(19) United States
(12) Patent Application Publication
(10) Pub. No.: US 2005/0060378 A1
(43) Pub. Date: Mar. 17, 2005

(54) Method and apparatus for providing language modularization

(76) Inventors: Joann K. Girard, Coconut Creek, FL (US); Ajit Mathews, Plantation, FL (US)

Correspondence Address: MOTOROLA, INC., 1303 EAST ALGONQUIN ROAD, IL01/3RD, SCHAUMBURG, IL, 60196, US

(21) Appl. No.: 10/663,305

(22) Filed: Sep. 16, 2003

(51) Int. Cl. G06F 15/16

(52) U.S. Cl. 709/206

(57) ABSTRACT

A language data package (102) includes a language pack section (104) that includes data for a particular language, text translations for the applications and the character font sets to support the particular language (e.g., Spanish, English, etc.). The language data package (102) further includes a rules database (108) for the language. The language data package (102) can be loaded into an electronic device (100) without the need to re-booting the electronic device and without the need for a file system.

### TECHNICAL FIELD

This invention relates in general to the field of electronics and more specifically to a method and apparatus for providing language modularization in an electronic device.

### BACKGROUND

Embedded software products and operating systems face a variety of challenges when being designed for use with multiple languages. The performance and memory resource constraints demanded by these embedded products often force software designers to know up-front which languages (e.g., French, English, etc.) will be supported by a particular product. In prior art designs, specific language translations are designated at compile-time and placed in fixed locations so that applications can quickly access them. The inherent limitation of this approach is that any new language that needs to be supported by the software (e.g., due to product entry in a new foreign country) requires a new release of the applications and, potentially, the operating system, which delays introduction of products into new markets and can introduce new defects into the product.

As such, a need exists in the art for a method and apparatus for providing language modularization that can minimize some of the problems previously mentioned.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a diagram of language data package components and how they interface to a given software application in accordance with an embodiment of the invention.

FIG. 2 shows a block diagram of a communication device in accordance with an embodiment of the invention.

FIG. 3 shows a diagram of a flash pack structure in accordance with an embodiment of the invention.

FIG. 4 shows a structure of a pack manger in accordance with an embodiment of the invention.

FIG. 5 shows a runtime architecture for the radio communication device shown in FIG. 2.

FIG. 6 shows a diagram of a flash pack structure for a language pack.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

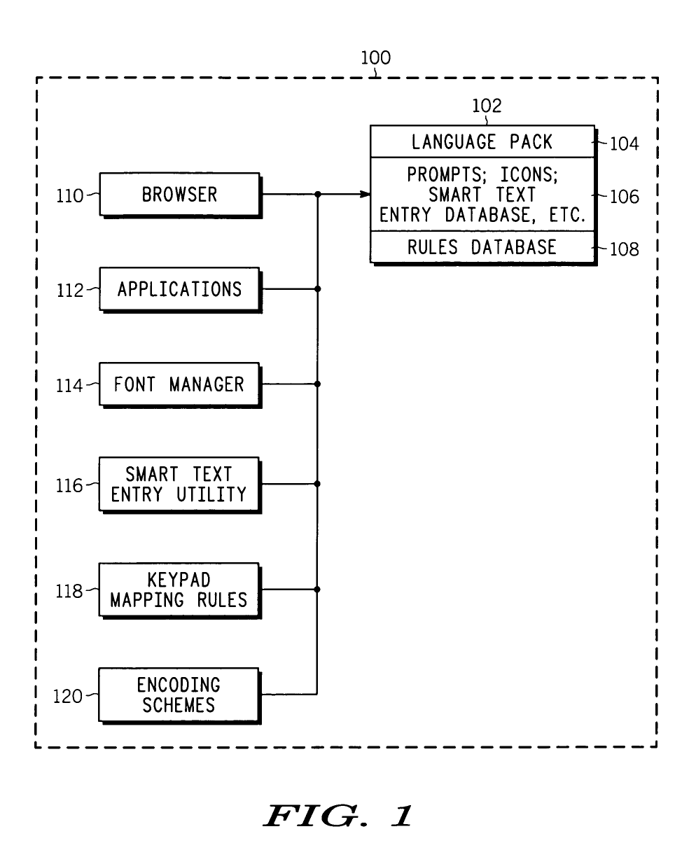

As shown in FIG. 1, all components that enable a software application to be customized to a given language are consolidated into a language data package 102. Unique information for all the applications, as well as data that is global to a given language, is combined into the consolidated language data package 102. The components of the language data package 102 includes a language pack 104 which includes data for a particular language (e.g., English, Spanish, Hebrew, etc.), text translations for the applications and the character font sets to support the particular language. Prompts, icons and any databases required for smart text entry 106 are also part of the language data package 102. Finally, a rules database 108 provides support for navigational rules (left-to-right versus right-to-left languages, e.g., Hebrew or Arabic) as well as key entry rules associated with the particular language. Culture-specific information may also be grouped into the language pack to further tailor the software for various locales. This information may include such items as icons, color palettes (urgent versus non-urgent color schemes), etc.

Each software component, including but not limited to, browser 110, applications 112, font manager 114, smart text entry utility 116, keypad mapping rules 118 and encoding schemes 120 found in electronic device 100 that require language information can access the information from the language data package 102. Language data package 102 can reside in memory within electronic device 100 such as flash memory, Random Access Memory (RAM), etc. Language data package 102 can be compressed and be sized such that it can be efficiently delivered to the electronic device 100 wirelessly (over-the-air) or using a tethered device such as a computer. Updates to an existing language data package 102 can also be done over-the-air. Installation and accessing of the language data package 102 is done without requiring a system re-boot.

Though at least one language data package 102 must always be resident in the electronic device, any number of additional languages may be loaded without recompilation of the software; the only limitation is the amount of memory. Removal or enhancement of a language is accomplished by removing or loading a new language data package 102.

As each application or function requires access to a data element, it makes use of an access function that obtains the data from the currently active language data package. For example, an application may request a text prompt from the application data package and, when it requests the operating system to draw the display, the function that handles graphic layout will then request the bitmaps for the character set and any graphic elements before composing the screen and updating the display.

Referring to FIG. 2, there is shown an electronic device such as a radio communication device 200 having a pack management system in accordance with an embodiment of the invention. The radio 200 includes a conventional receiver section 204 and a conventional transmitter section 206 selectively coupled to an antenna 222. A controller such as a microprocessor and/or digital signal processor (DSP) 202 provides the overall control for radio 200. A display 208 and user controls 210 such as a keypad and other controls provide the user interface for radio 200. In accordance with an embodiment of the present invention, a memory such as a flash memory 212 is used to store a plurality of language data packages (also referred to as flash packs or language packs) 214 having a predefined starting address 216 and ending address 218. A pack manager 220 who handles the duties of loading and unloading the language packs 214 is also stored in the flash memory 212. Although a flash memory 212 is used in this embodiment, other types of memory known in the art, such as, Random Access Memory (RAM) or nonvolatile memory can be used.

Controller 202 is in charge of accessing the language packs 214 and deciding which language pack 214 is the currently active language package. The controller 202 accesses all language specific information from the currently active package. For example, an application in radio 200 may request a text prompt from the currently active language package 214 (for example language package 1). When the application requests the operating system to draw the display, functions that handle graphic layout will then request the bitmaps for the character set and any graphic elements before composing the screen and updating the display.

Periodically, the operating system of radio 200 will search for the available language packs 214, confirm their integrity, and designate one language pack as the currently active language. In one embodiment of the invention, the search will be conducted at power-up of radio 200. However, a more dynamic system can perform the necessary checks when a change is detected in the language pack memory space 212.

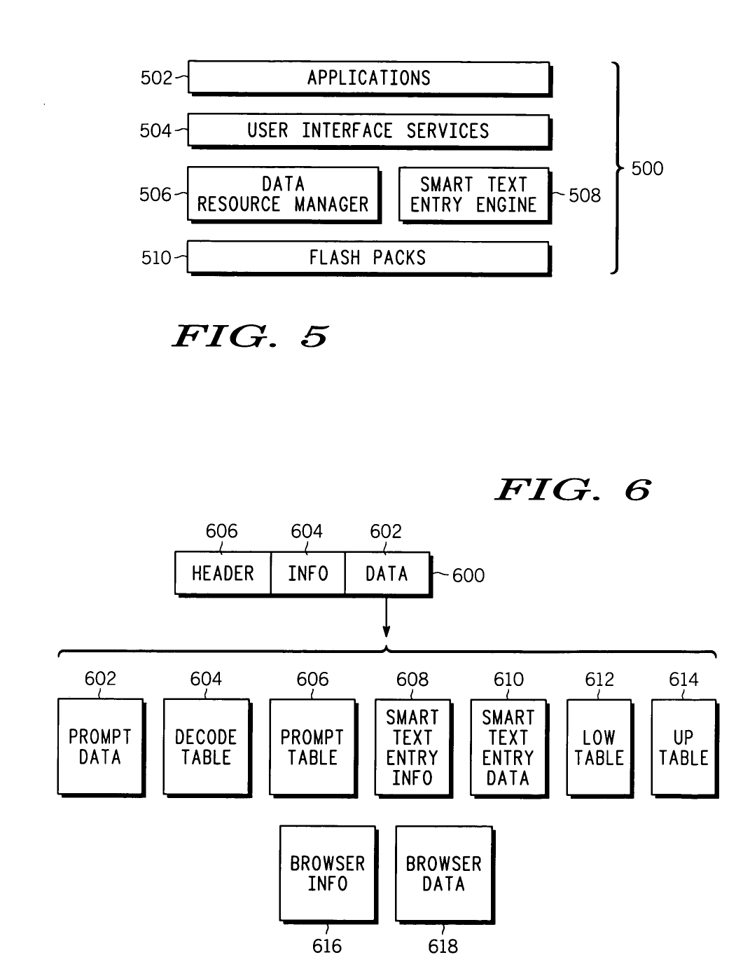

The flash packs 214 are located starting at a fixed location in flash memory, in this example starting address 216; however, this location can vary from product to product. The starting position will be defined by the memory map of the radio 200. Having a fixed starting location for the first flash pack (pack 1) 214 affords the advantage of making the flash packs 214 easy to find during the power-up sequence of radio 200. During the power up initialization of the Data Resource Manager (DRM) (FIG. 5) located in the radio communication device, a pointer to this starting location will be retrieved through a function call in accordance with an embodiment of the invention.

The DRM is responsible at runtime for reading the flash pack memory region and determining what flash packs have been loaded. Memory pointers are set up so that the data contained in the packs may be accessed. After this step, the use of the resources should be transparent to the clients using the data, since there should be no difference between a flash pack and a non-flash pack configuration as far as accessing the data.

A flash pack 214 in accordance with an embodiment of the present invention can be loosely defined as an image file that may be flashed into a radio such as radio 200. A flash pack is intended to be a “package” that can be “plugged” into the radio 200. This provides an opportunity for configuring the radio 200 with different languages. The data that comprises any of these languages are located in C language files that are generated using an editor tool. At build time, the file is compiled into an object file and is then linked into the image that carries the data for supporting the particular language. By using the flash pack system, it is possible to add/delete different languages without having to rebuild the radio's subscriber software code. If a new feature such as support for a new language is required, using the flash system, the new language is simply “flashed” into the radio 200.

The flash pack system of the present invention contains both runtime and non-runtime components. The non-runtime components of the flash pack system are responsible for taking input data, for example, taking text prompt data, and creating image files (flash packs 214) that may be flashed into radio 200. The flash packs 214 may then be flashed into the radio's flash memory 212. Once this occurs, the data flashed into the memory 212 is simply hex data, and has no linkage to the compiled radio's “subscriber” code. The runtime components of the system are responsible for searching the designated flash pack memory region in the radio and loading any packs that it finds. The runtime software's job is to find the flash packs 214 and decode the data in them.

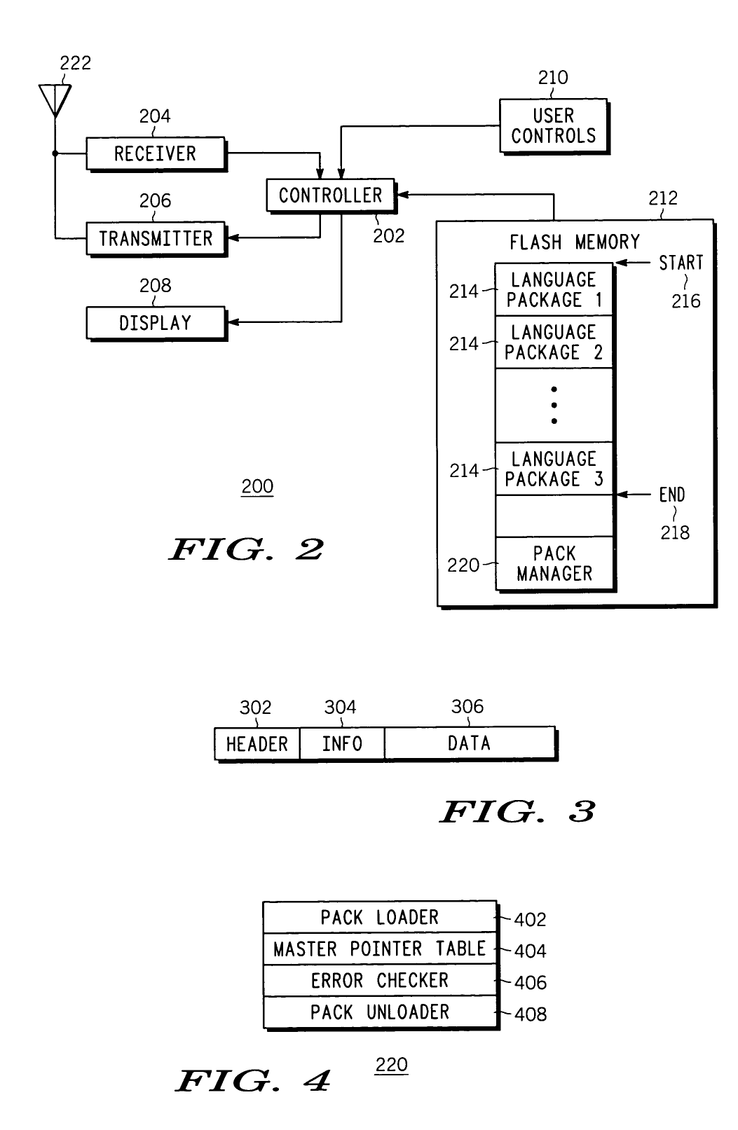

In FIG. 3 there is shown a typical flash pack structure in accordance with an embodiment of the invention. The flash pack is broken into a header portion 302, an info portion 304 and a data portion 306. The header portion 302 is used to provide identity to the flash pack as well as to identify that it is a language pack. The header portion 302 includes a unique identifier for verifying that a flash pack has been found when a search is performed for a pack by the pack manager. The header portion 302 also includes version (e.g., software version) and size information.

The information or info portion 304 is unique for language packs that are loaded. The info portion 304 includes information regarding the sizes of the data located in the data portion 306. The contents of the information section are specific to the type of flash pack (e.g., a bit map pack, a font pack, etc.). Additionally, a checksum is located in this section for ensuring the integrity of the data section. Finally the data portion 306, like the info portion 304, is unique to the type of flash pack being used; it can for example be arrays of any type of data, depending on the data being carried.

In FIG. 4, there is shown a structure of the pack manager 220 in accordance with an embodiment of the present invention. The pack manager 220 comprises a pack loader routine 402, a master pointer table 404, an error checker 406 and a pack unloader routine 408. The pack loader routine 402 is in charge of loading language packages into flash memory 212. A master pointer table 404 is used to keep track of the starting 216 and ending 218 addresses of the language packages 214 and any other pointer information needed to access the language packages 214. The pack manager 220 also includes an error checker 406 for checking the integrity of the language packages that are loaded into flash memory 212. Finally, the pack manager 220 includes a pack unloader routine that is used to unload any language packages that are stored in flash memory 212 and are no longer needed.

A language pack (flash pack) runtime architecture 500 for radio 200 is shown in FIG. 5. The architecture at the highest level includes applications 502, User Interface Services (UIS) 504, the DRM 506, and a Smart Text Entry engine 508 which are part of the radio's architecture, and the language packs 510 of the present invention. An example of a Smart Text Entry engine 508 that can be used with the present invention includes the T9™ text entry engine developed by Tegic Communications. The DRM 506 is responsible for reading the pack memory region at runtime and determining which packs have been loaded into the radio. Upon determining what packs have been loaded, the memory pointers are set up so that the data contained in the packs may be accessed. After this step the use of the resources should be transparent to the clients of the data (e.g., there should be no difference between a flash pack and non-flash pack configuration as far as accessing the data).

In FIG. 6, there is shown a diagram of a language pack 600 with the data section broken down into some of its parts. The header portion 606 contains no specific language pack information, while the info portion 604 contains specific language information that is used at run-time to help the DRM/flash pack initialization find and interpret the flash pack structure from memory. The info portion 604 includes a data type that is used by the DRM initialization routine to set up the language. In addition to this, it contains the sizes of the pieces of data in the data portion 602 as well as a checksum for the data.

The data portion 602 of language pack 600 contains all of the necessary data that the DRM needs in order to use a language as well as hold the smart text entry database for the language. The first three data sections: prompt data 602, decode table 604 and the prompt table 606 are used by the DRM to display a language in an electronic device such as radio 200. The smart text entry info 608 and smart text entry data 610 hold the smart text entry database (e.g., T9™ database) for the particular language in question. The low table 612 and the up table 614 provide information for the lower case and upper case character sets for the language. Finally, the browser info 616 and browser data 618 ensures that the browser data specific to a particular language is in memory only when necessary.

The present invention is hardware agnostic, and does not require use of a file system which is very important when implemented in portable electronic devices such as radio telephones. Access to the data may be stored in whatever memory is available to the embedded device, and can be accessed very rapidly. The language modularization technique of the present invention allows for updating of the language packs without having to re-release operating system software or reload applications.

With the language pack system in place, it is possible to manufacture products that have an identical subscriber load, yet have different language configurations. In effect, the languages available on a product may be added or removed without requiring a rebuild of the product's (e.g., a radio) software. When a language other than the default language (e.g., English) is desired for a product, the flash pack file for the desired language is simply flashed into the product. This process can be repeated to add more languages. By separating and later loading any required language-specific data prevents wasted memory space at compile-time for unused language information. Furthermore, by using access functions that access language specific data from the currently active language pack, the data can reside wherever is most efficient for a given product. Thus, data can be accessed directly from flash memory, Random Access Memory (RAM), etc.

While the preferred embodiments of the invention have been illustrated and described, it will be clear that the invention is not so limited. Numerous modifications, changes, variations, substitutions and equivalents will occur to those skilled in the art without departing from the present invention as defined by the appended claims.

1. An electronic device that supports at least one language, comprising:
a memory;
at least one language data package located within the memory having an image file that contains data on the at least one language;
a pack manager, wherein the pack manager is used for loading and unloading the at least one language pack into and out of memory; and
wherein the at least one language data package can be loaded and accessed by the electronic device without having to perform a system re-boot.

2. An electronic device as defined in claim 1, wherein additional language data packages may be loaded into the electronic device without recompilation of the electronic device's software.

3. An electronic device as defined in 1, wherein the at least one language data package comprises all components necessary for the electronic device to use the language supported by the language data package.

4. An electronic device as defined in claim 3, wherein the at least one language data package further comprises character font sets to support the at least one language.

5. An electronic device as defined in claim 3, wherein the at least one language data package further comprises a rules database that includes navigational rules for the at least one language.

6. An electronic device as defined in claim 5, wherein the at least one language data package comprises key entry rules for text entry and any databases required for smart text entry.

7. An electronic device as defined in claim 3, wherein one of the components in the at least one language data package comprises culture specific information that further comprises character font sets.

8. An electronic device as defined in claim 7, wherein the culture specific information further comprises color schemes that are displayed by the electronic device.

9. An electronic device as defined in claim 1, wherein the electronic device comprises a radio communication device.

10. An electronic device as defined in claim 9, wherein the at least one language data package can be updated over-the-air.

11. An electronic device as defined in claim 9, wherein the at least one language data package is updated using a computer that is tethered to the electronic device.

12. A radio communication device that supports at least one language, comprising:
a memory;
a language data pack located within the memory, wherein the language data pack comprises an image file that contains data on the at least one language, the language data pack further comprising all components necessary for the radio communication device to use the language supported by the language data pack.

13. A radio communication device as defined in claim 12, wherein the language data pack further comprises a rules database which contains rules for using the at least one language.

14. A radio communication device as defined in claim 13, wherein the rules database comprises navigational rules for the at least one language.

15. A radio communication device as defined in claim 12, wherein the language data pack further comprises a smart text entry database.

16. A radio communication device as defined in claim 12, wherein the updating of the language data pack does not require reloading of applications found in the radio communication device.

17. A method for providing language support for an electronic device having a memory, comprising the steps of:
loading a language data pack in the memory, the language data pack comprising an image file that contains data on a language; and
retrieving data from the language data pack whenever the electronic device requires information related to the language.

18. A method as defined in claim 17, wherein the language data pack further comprises all components necessary for the electronic device to use the language.

19. A method as defined in claim 17, wherein the language data pack further comprises a rules database that contains rules for using the language.

20. A method as defined in claim 17, wherein the language data pack further comprises a smart text entry database.
